(19) United States
(12) Patent Application Publication
(10) Pub. No.: US 2023/0237199 A1
(43) Pub. Date: Jul. 27, 2023

(54) REMOTE COMMAND EXECUTION OVER AN AIR-GAP SECURED SYSTEM

(71) Applicant: Dell Products L.P., Round Rock, TX (US)

(72) Inventors: Jehuda Shemer, Kfar Saba (IL); Stav Sapir, Beer Sheva (IL); Naor Radami, Shokeda (IL); Amihai Savir, Newton, MA (US)

(21) Appl. No.: 17/648,630

(22) Filed: Jan. 21, 2022

(51) Int. Cl. G06F 21/64; G06F 21/31; G06F 21/54; G06F 21/60

(52) U.S. Cl. CPC G06F 21/64; G06F 21/31; G06F 21/54; G06F 21/602; G06F 2221/0751

(57) ABSTRACT

One example method includes reading, at an air-gapped system, a code provided by a control system, and the code includes a message containing instructions from the control system to the air-gapped system, checking, by the air-gapped system, the message to determine if the message includes a command executable by the air-gapped system, and when the message identifies a command executable by the air-gapped system, and the command is included in a list of authorized commands, executing, by the air-gapped system, the command.

### FIELD OF THE INVENTION

Embodiments of the present invention generally relate to command and control of air-gapped systems. More particularly, at least some embodiments of the invention relate to systems, hardware, software, computer-readable media, and methods for remote command execution at an air gap secured system.

### BACKGROUND

Air-gapped machines are in use in many applications. To illustrate, the Cyber Recovery solution by Dell Technologies uses an air-gapped Data-Domain (DD) to store backups in a secure vault. The airgap is implemented by a physical disconnection of the machine from any network, system, or other machine, thus preventing a remote attack on the air-gapped machine. The gap is closed only for a short time to transfer backup data and then disconnected again. Another popular use for airgaps is in electronic voting machines. Voters have a display to cast their vote, but the machines are disconnected from networks to prevent voting tampering. While airgaps can be effective in preventing access to an air gapped element, problems exist with current implementations.

For example, running any command on the air gapped machine may be a problem. Particularly, in order to run a command, the entity that wishes to run the command needs either physical access to the machine, or must close the airgap and connect remotely, either of which would defeat the purpose of the airgap. Any remote connection, such as Secure Shell (SSH) and email for example, requires a protocol handshake which can be used as an opportunity for attack. Thus, the airgap should be closed only when absolutely necessary, and for the minimum time possible.

Another problem in secure systems like Cyber Recovery or voting machines, is that malicious attackers can attempt to falsify outputs or status, to give incorrect results, or to trick the admin into closing the airgap to the machine. In voting machines, the gap is closed, or a device attached to the machine, when polling stations are closed to get the voting count, thus providing an opportunity for an attack.

At present then, executing commands on an air-gapped machines requires a connection to the machine which requires physical access to the machine, or requires closing the airgap between the machine and another machine. There is also a need to make sure status is not falsified.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment for some embodiments of the invention.

FIG. 2 discloses aspects of an example system for remote command execution in an air-gapped system, according to some embodiments.

FIG. 3 discloses an example method according to some embodiments.

FIG. 4 discloses an example computing entity operable to perform any of the claimed methods, processes, and operations.

### DETAILED DESCRIPTION OF SOME EXAMPLE EMBODIMENTS

Embodiments of the present invention generally relate to command and control of air-gapped systems. More particularly, at least some embodiments of the invention relate to systems, hardware, software, computer-readable media, and methods, for remote command execution at an air gap secured system.

In general, example embodiments of the invention may provide a mechanism to securely provide executable commands to an air-gapped system without impairing the integrity of the air gap. As used herein, an air-gapped ‘system’ or ‘machine’ is intended to be broadly construed and embraces, but is not limited to, any combination of hardware elements and/or software elements that are operable to execute one or more commands.

At least some embodiments are directed to a system that may include a standard display monitor connected to a network, such as the Internet for example, and used to display a message code which may be signed, and optionally encrypted, and may be formatted as a visual code, one example of which is a QR (Quick Response) code. A camera connected to the air-gapped machine, and isolated together with the air-gapped machine as a single unit, reads the visual code off the display, which is located outside of the air-gapped machine, and sends the visual code as an input to the air-gapped machine. The air-gapped machine may then read the code, validate the authenticity of the code using cryptographic tools, map the code into one of a number of predefined and pre-authorized commands, and then execute the corresponding command. In this way, verified commands can be executed by an air-gapped system, without ever requiring a physical connection to the air-gapped system by an outside entity, such as a human, or other system.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may be configured so that instructions may be communicated to an air-gapped system without the use of a physical connection between the air-gapped system and the entity that communicates the instructions. An embodiment may prevent malicious attacks on a system by maintaining an air gap between that system and any outside entities. An embodiment may enable execution, by an air-gapped system, of a command based on instructions received over an air gap from an entity that is not physically connected to the air-gapped system. Other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Both administrative personnel and users may be required to execute commands at an air-gapped system. For example, and similar to the case for components such as servers for example, there may be a need to run various commands on the air-gapped system, such as to get alerts, run tests, or change a configuration, that requires physical access to the machine, that is, closing the airgap between the system and outside entities. While, attackers can attack the system when the airgap is closed, if there is no way to get to the machine, there is no way to attack it. Thus, attackers may then try to attack peripheral interfaces or admins in order to gain access to the machine. One particular attack vector that may be employed is the falsification of outputs from the peripheral interfaces or admins. For example, if an attacker can falsify outputs to indicate that the air-gapped machine is down, an admin may close the gap and connect to the air-gapped machine to try to figure out the problem, thereby exposing the machine to an attack. In the particular example of voting machines, this approach may be used to falsify voting results.

### B. Aspects of Some Example Embodiments

At least some example embodiments may be directed to addressing the problem of transmitting instructions to an air-gapped system for the execution of commands by that system. To that end, some embodiments may employ a cryptographically signed visual code, such as an encrypted QR code for example, to cause the execution of one or more pre-defined commands. The visual code may be configured for one-time use only, and may only be valid for a limited period of time. No physical connection to the air-gapped system is needed. A device such as a camera may be used to visually read the code.

In more detail, embodiments may employ a cryptographically signed, and possibly asymmetrically encrypted, messages that may be represented as a visual code. The code may be exposed to the air-gapped system using a limited input device such as camera. The camera may be located within the secured room, such as in a safe with only a small window for the lens, thus ensuring complete isolation between the user and the air-gapped system.

Note that embodiments are not limited to the use of any particular type of media, such as two-dimensional visual codes, for enabling the conveyance of instructions from an entity to an air-gapped system. Various other types of media may be employed as well, one example of which is three-dimensional codes such as holograms. In still other embodiments, such media may include sounds with encrypted information that may be perceived, that is, read, by a microphone or similar device that is in communication with an air-gapped system.

In general, example embodiments may implement functionalities that may ensure that: (1) commands can be executed remotely in an air-gapped system without the airgap closed; and (2) no human or other system can run commands on the air-gapped system without authorization. In general, the command that is being enabled for execution by the air-gapped system may be one of a predefined list of commands that are mapped into a code. That is, in some embodiments, any command not on that list will not be performed by the air-gapped system, even if instructions to execute such a command are received from an authorized source. As well, embodiments may provide that each code, such as a QR code, is valid only for a limited time, and/or only for a single use. Note that although parts of this disclosure may refer to a QR code, various other types of visual codes may be employed, such as, but not limited to, visual codes that have sufficient length, such as barcodes, JAB (Just Another Bar) code, multi-colored HCC2D (High Capacity Colored Two Dimensional) codes, PDF417 (stacked linear barcode), Aztec or any other 2D or 3D visual coding method.

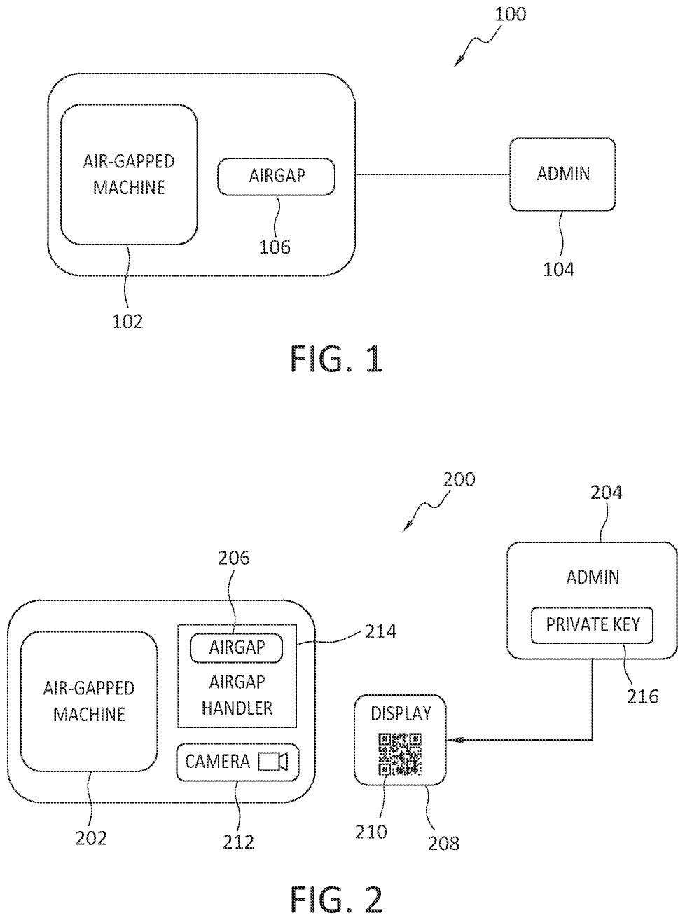

With attention now to FIG. 1, details are provided concerning an example configuration 100 in connection with which embodiments of the invention may be employed. In general, an air-gapped machine 102 may be physically isolated from any other system or device 104, by way of an air gap 106. That is, the air-gapped machine 102 is not physically connected, such as by a cable or other physical element(s), to any other system or device 104.

### B.1. System Configuration

Turning next to FIG. 2, details are provided concerning aspects of an example embodiment of the invention. As shown FIG. 2, the configuration 200 may comprise an air-gapped machine 202 may be physically isolated from any other system or device 204, by way of an air gap 206. That is, the air-gapped machine 202 is not physically connected, such as by a cable or other physical element(s), to any other system or device 204.

The configuration 200 may further comprise a display 208 that may be connected to, and controllable by, a system 204, such as an admin system for example. The admin system may be broadly referred to herein as the control system since the admin system may control the operation of the air-gapped machine 202. The display 208 may comprise any system or device, such as a monitor for example, that is operable to visually display graphical information, such as a code for example. In general, the display 208 may be operable, in response to a command from the system 204, to present, visually or in some other perceptible way, a code 210. The code 210 may be presented in a form that is perceptible by a reader 212 that is isolated, together with the air-gapped machine 202, by the air gap 206. For example, the reader 212 may be physically connected to, and communicate with, the air-gapped machine 202. Where the code 210 takes a visually perceptible form, the reader 212 may comprise a camera, but the scope of the invention is not limited to visually perceptible codes, nor to readers in the form of a camera.

The use of the code 210 thus enables the system 204 to communicate with, and control the operation of, the air-gapped machine 202, without any physical connection between the system 204 and the air-gapped machine 202. More particularly, and with continued reference to FIG. 2, the reader 212 may capture a code 210 presented by the display 208. The code 210 itself, and/or information in the code 210, may then be sent by the reader 212 to the air-gapped machine 202. The air-gapped machine 202, or an air gap handler 214 that implements the air gap 206, may then decode the code 210.

If the air-gapped machine 202 performs the decoding, the air-gapped machine 202 may then compare the decoded information with a list of commands, which may reside at the air-gapped machine 202, and if there is a match, the air-gapped machine 202 may execute the matching command(s). If there is no match between the coded information and one or more commands in the list, then the air-gapped machine 202 may take no action. If the air gap handler 214, rather than the air-gapped machine 202, performs the decoding, the air gap handler 214 may transmit the decoded information to the air-gapped machine 202 which may then operate as just described to identify, and execute, any matching commands.

### B.2. Security

With continued reference to the example of FIG. 2, embodiments may provide for cryptographic signing of the code 210 to avoid a situation where a falsified code 210 is read by the reader 212. Particularly, if a system were configured to simply employ a display and a camera, and present, as a code, commands from an admin, then an attacker could attack the display, which may be connected to a network, and falsify the code in an attempt, for example, to induce the air-gapped machine to perform an unauthorized operation. Thus, the air-gapped machine needs assurance that the instructions to execute a command or perform a function have validly originated in the admin system, and that the presented code was not tampered with.

Accordingly, example embodiments may employ an asymmetric cryptographic key-pair to ensure the integrity of the codes presented to the air-gapped system. For signing, in some embodiments, a private key 216 of the key pair may be stored securely on the system 204. The air-gapped system 202 and/or air gap handler 214 may have the public key that corresponds to the private key 216. Every code 210 may be signed by the system 204 using the private key 216. The message, such as instructions by the system 204 to the air-gapped system 202 to perform one or more commands, and signature may be given as the coded QR code.

In this way, the air gap handler 216 and/or the air-gapped machine 202 may use the public key to ensure: (1) only an authorized system, such as the system 204, can be the producer of the message, that is, the code 210; (2) the content in the code 210 is valid and has not been tampered with; and (3) the time of the message, so as to avoid replay attacks initiated by an attacker at times other than the time specified in the message. Any asymmetric cryptography signing method may be used in example embodiments. Such cryptographic signing methods include, but are not limited to, RSA (Rivest-Shamir-Adleman) and ECDSA (Elliptic Curve Digital Signature Algorithm).

If encryption is to be employed, a second set of keys may be provided for encryption, since the public key of the first key pair may be compromised, thus rendering the encryption useless. If both parts of the key are secure, then one set may be enough.

With particular reference to the possible use of a second key pair in some embodiments, it is noted that asymmetric cryptography uses a key pair: a private key; and a public key which is assumed to be accessible to anyone. The keys in this key pair may give rise to two use cases:

1. Digital signatures. Use the private key to sign—only the holder of the private key can sign, and anyone can verify the authenticity of the signature—use the public key for this verification; and

2. Encryption. Anyone can create an encrypted message using the public key, but only one person can read the confidential information, that is, the person holding the private key.

A useful aspect of the public key, in the encryption use case, is that a party can generate the key pair, keep the private key private for use in decryption, and freely send the public key out for other parties to use in encrypting information. The public key can be sent freely over non-secure mediums, or even published in a newspaper, for example. The integrity of the encrypted data is not compromised by knowledge of the public key, since only the holder of the private key can decrypt the information that was encrypted with the public key.

In some example embodiments, the message in the code presented to the reader may be both signed, and then encrypted. One way to implement this approach may be to keep both the public and private key hidden. However, it may not always be possible to keep the public key confidential.

Alternatively, embodiments may implement an approach that involves the use of two different public/private key pairs. In this alternative approach, one of the key pairs may be used to sign the message, and another of the key pairs may be used to encrypt the signed message. For example, the system may use a private key of a first key pair to sign a message, and the air-gapped system can then authenticate that signature using the public key that corresponds to that private key. For encryption, the system may use the public key of the second key pair to encrypt the digitally signed message, and the air-gapped system may use the corresponding private key of the second key pair to decrypt the digitally signed message.

### C. Further Discussion

As disclosed herein, example embodiments may provide various useful features. For example, some embodiments may the ability to remotely execute commands in an air-gapped system. Embodiments may employ optical separation, and cryptographically secure messages, to provide admins and users of the system the ability to communicate with the air-gapped machine while maintaining the integrity of the air

### D. Example Methods

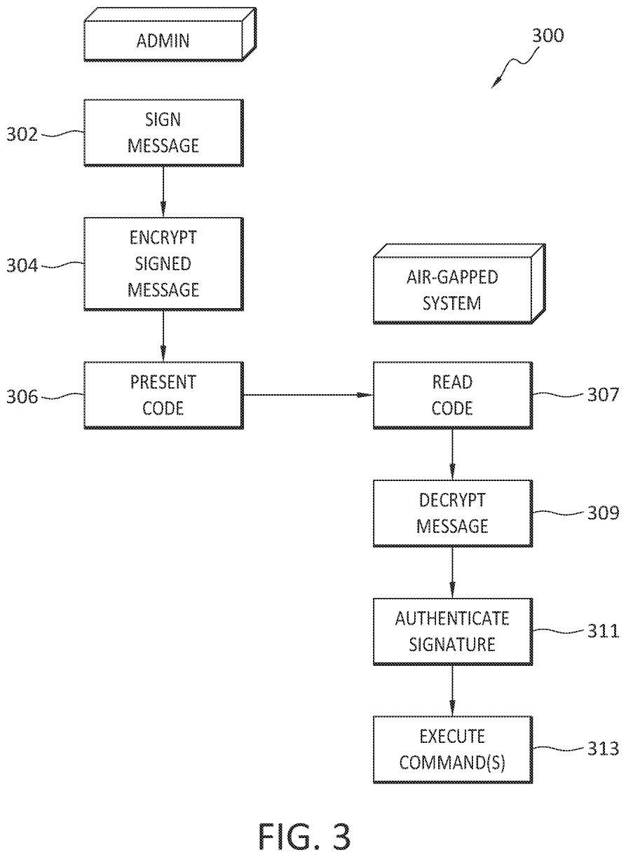

It is noted with respect to the example method of FIG. 3 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 3, an example method 300 may be cooperatively performed by a system, such as an admin system, and an air-gapped system that is physically unconnected to the admin system. As well, the air-gapped system may not be physically connected to any other system, and may include a reader by way of which the air-gapped system is able to receive communications from the admin system.

The method 300 may begin when the admin system creates and signs 302 a message intended for the air-gapped system. The message need not have any particular content. In some embodiments, the message may comprise instructions to the air-gapped system to execute one or more particular commands or operations. A list of authorized commands may reside at, or be otherwise accessible by, the air-gapped system.

After the message has been signed 302, the admin may also encrypt 304 the signed message. The admin may then generate 306, and present to the air-gapped system, a code that includes the signed, encrypted, message. In some embodiments, the presentation 306 of the code may comprise visually displaying the code.

Regardless of the media or manner used to present 306 the code, the air-gapped system may then read 307 the code that has been presented. In some embodiments, the read 307 may be performed with a camera.

After the code has been read 307, the air-gapped system may then decrypt 309 the message included in the code. The decrypted message may include a signature that was added by the admin. Thus, the signature may be authenticated 311 by the air-gapped system. If the authentication is successful, the air-gapped system may then execute 313 any commands that (1) were included in the message, and (2) appear on a list of authorized commands for the air-gapped system.

### E. Further Example Embodiments

Following are some further example embodiments of the invention. These are presented only by way of example and are not intended to limit the scope of the invention in any way.

Embodiment 1. A method, comprising: reading, at an air-gapped system, a code provided by a control system, and the code includes a message containing instructions from the control system to the air-gapped system; checking, by the air-gapped system, the message to determine if the message includes a command executable by the air-gapped system; and when the message identifies a command executable by the air-gapped system, and the command is included in a list of authorized commands, executing, by the air-gapped system, the command.

Embodiment 2. The method as recited in embodiment 1, wherein the message is encrypted, and the air-gapped system decrypts the message to access the instructions.

Embodiment 3. The method as recited in any of embodiments 1-2, wherein the message is digitally signed by the control system, and the air-gapped system authenticates a digital signature of the control system before executing any commands, and no commands are executed by the air-gapped system if authentication fails.

Embodiment 4. The method as recited in any of embodiments 1-3, wherein there is no physical connection between the control system and the air-gapped system at any time during performance of the method.

Embodiment 5. The method as recited in any of embodiments 1-4, wherein the code is a visually perceptible code that is read by a camera associated with the air-gapped system.

Embodiment 6. The method as recited in any of embodiments 1-5, wherein the method is both digitally signed by the control system, and encrypted by the control system.

Embodiment 7. The method as recited in any of embodiments 1-6, wherein the code is a single-use code.

Embodiment 8. The method as recited in any of embodiments 1-7, wherein the code is only valid to instruct the air-gapped system during a specified period of time.

Embodiment 9. The method as recited in any of embodiments 1-8, wherein the message is digitally signed, and encrypted, using respective sets of public-private keys.

Embodiment 10. The method as recited in embodiment 9, wherein the air-gapped system holds: a public key of the public-private key pair used for digitally signing the message; and a private key of the public-private key pair used to encrypt the message.

Embodiment 11. A system comprising hardware and/or software for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

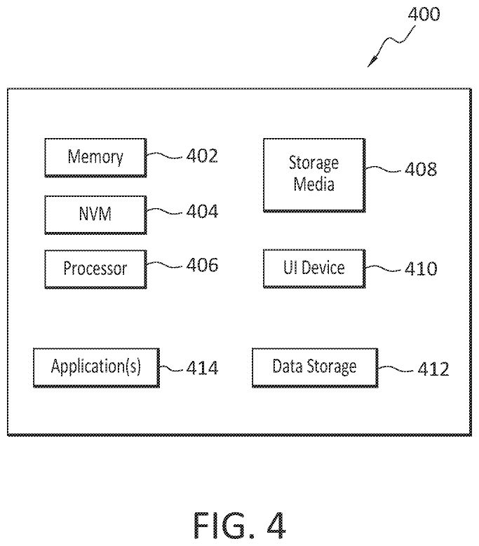

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
reading, at an air-gapped system, a code provided by a control system, and the code includes a message containing instructions from the control system to the air-gapped system;
checking, by the air-gapped system, the message to determine if the message includes a command executable by the air-gapped system; and
when the message identifies a command executable by the air-gapped system, and the command is included in a list of authorized commands, executing, by the air-gapped system, the command.

2. The method as recited in claim 1, wherein the message is encrypted, and the air-gapped system decrypts the message to access the instructions.

3. The method as recited in claim 1, wherein the message is digitally signed by the control system, and the air-gapped system authenticates a digital signature of the control system before executing any commands, and no commands are executed by the air-gapped system if authentication fails.

4. The method as recited in claim 1, wherein there is no physical connection between the control system and the air-gapped system at any time during performance of the method.

5. The method as recited in claim 1, wherein the code is a visually perceptible code that is read by a camera associated with the air-gapped system.

6. The method as recited in claim 1, wherein the method is both digitally signed by the control system, and encrypted by the control system.

7. The method as recited in claim 1, wherein the code is a single-use code.

8. The method as recited in claim 1, wherein the code is only valid to instruct the air-gapped system during a specified period of time.

9. The method as recited in claim 1, wherein the message is digitally signed, and encrypted, using respective sets of public-private keys.

10. The method as recited in claim 9, wherein the air-gapped system holds:
a public key of the public-private key pair used for digitally signing the message; and
a private key of the public-private key pair used to encrypt the message.

11. A non-transitory storage medium having stored therein instructions that are executable by one or more hardware processors to perform operations comprising:
reading, at an air-gapped system, a code provided by a control system, and the code includes a message containing instructions from the control system to the air-gapped system;
checking, by the air-gapped system, the message to determine if the message includes a command executable by the air-gapped system; and
when the message identifies a command executable by the air-gapped system, and the command is included in a list of authorized commands, executing, by the air-gapped system, the command.

12. The non-transitory storage medium as recited in claim 11, wherein the message is encrypted, and the air-gapped system decrypts the message to access the instructions.

13. The non-transitory storage medium as recited in claim 11, wherein the message is digitally signed by the control system, and the air-gapped system authenticates a digital signature of the control system before executing any commands, and no commands are executed by the air-gapped system if authentication fails.

14. The non-transitory storage medium as recited in claim 11, wherein there is no physical connection between the control system and the air-gapped system at any time during performance of the non-transitory storage medium.

15. The non-transitory storage medium as recited in claim 11, wherein the code is a visually perceptible code that is read by a camera associated with the air-gapped system.

16. The non-transitory storage medium as recited in claim 11, wherein the non-transitory storage medium is both digitally signed by the control system, and encrypted by the control system.

17. The non-transitory storage medium as recited in claim 11, wherein the code is a single-use code.

18. The non-transitory storage medium as recited in claim 11, wherein the code is only valid to instruct the air-gapped system during a specified period of time.

19. The non-transitory storage medium as recited in claim 11, wherein the message is digitally signed, and encrypted, using respective sets of public-private keys.

20. The non-transitory storage medium as recited in claim 19, wherein the air-gapped system holds:
a public key of the public-private key pair used for digitally signing the message; and
a private key of the public-private key pair used to encrypt the message.
